(19) United States
(12) Patent Application Publication
(10) Pub. No.: US 2006/0037717 A1
(43) Pub. Date: Feb. 23, 2006

(54) Shutter with slat guides

(76) Inventors: Thomas R. Briscoe, Naples, FL (US); Harley E. Briscoe, Naples, FL (US)

Correspondence Address: EDWARD M. LIVINGSTON, PA, 963 TRAIL TERRACE DRIVE, NAPLES, FL, 34103, US

(21) Appl. No.: 11/253,471

(22) Filed: Oct. 19, 2005

Related U.S. Application Data
(63) Continuation-in-part of application No. 10/647,673, filed on Aug. 25, 2003.
Application No. 10/647,673 is a continuation of application No. 09/966,622, filed on Oct. 1, 2001, now abandoned.

(51) Int. Cl. E06B 3/48

(52) U.S. Cl. 160/117

(57) ABSTRACT

A shutter having predetermined requisite strength of shutter framework (1) encompassing slatted-louver apertures (31) with slat-support guides (6). The shutter framework includes structural beams to which ends of slanted slats (5) are attached rigidly. Ends of slat-support guides (6) and (7) are affixed to the bottom and top of shutter spacers (4) and preferably welded periodically to sides of the shutter framework (1).

### CROSS REFERENCE TO RELATED APPLICATION

This is a continuation in part of application Ser. No. 10/647,673 filed on Aug. 25, 2003, which was a continuation of application Ser. No. 09/966,622 filed Oct. 1, 2001, now abandoned.

### BACKGROUND OF THE INVENTION

This invention relates to shutters and more particularly to a shutter with slat guides that is attractive.

Examples of the most-closely related known but different devices are described in the following patent documents:

| Number | Inventor | File Date | Issue Date | Classification |
|---|---|---|---|---|
| U.S. Pat. No. 6,536,174 B | Foster et al. | May 07, 2001 | Mar. 25, 2003 | 52/473 |
| U.S. Pat. No. 3,039,155 | Iacovoni | Oct. 07, 1959 | Jun. 19, 1962 | 49/67 |
| U.S. Pat. No. 5,737,874 | Sipos et al. | Dec. 15, 1994 | Apr. 14, 1998 | 49/67 |
| U.S. Pat. No. 5,907,929 | Poma et al. | Nov. 21, 1997 | Jun. 01, 1999 | 49/62x |
| U.S. Pat. No. 5,617,683 | Ney | Mar. 25, 1996 | Apr. 08, 1997 | 52/202 |
| U.S. Pat. No. 4,368,594 | Milam et al. | Feb. 12, 1981 | Jan. 18, 1983 | 49/67 |
| U.S. Pat. No. 2,013,824 | Ensminger | | September 1935 | 160/77 |
| U.S. Pat. No. 1,646,522 | Berg | | October 1927 | 49/356 |
| U.S. Pat. No. 2,716,785 | Schoen | Oct. 21, 1953 | Sep. 06, 1955 | 49/67 |
| U.S. Pat. No. 3,667,161 | Sassano | Oct. 16, 1970 | Jun. 06, 1972 | 49/56 |
| U.S. Pat. No. 3,691,687 | Economou | Aug. 06, 1971 | Sep. 19, 1972 | 49/74 |

### SUMMARY OF THE INVENTION

Objects of patentable novelty and utility taught by this invention are to provide a shutter with slat guides which:
are attractive in appearance; and
can be made attractive in a variety of structural styles.

This invention accomplishes these and other objectives with a shutter having slat guides and a framework encompassing slatted-louver apertures for covering welds and housing the shutter slats at a 45 degree angle. The framework includes structural beams to which ends of slanted slats are attached rigidly.

### BRIEF DESCRIPTION OF DRAWINGS

This invention is described by appended claims in relation to description of a preferred embodiment with reference to the following drawings which are explained briefly as follows:

FIG. 1 is a partially cutaway front elevation view of a shutter embodiment of the present invention;

FIG. 2 is a section view through line 2-2 of FIG. 1;

FIG. 3 is a section view through line 3-3 of FIG. 1;

FIG. 4 is a section view of a framework member;

FIG. 5 is a section view of a mullion-slat-support guide assembly;

FIG. 6 is a section view through line 6-6 of FIG. 1;

FIG. 7 is a side view of a left slat-support guide;

FIG. 8 is a side view of a right slat-support guide;

FIG. 9 is a perspective view of a left slat-support guide;

FIG. 10 is a perspective view of a right slat-support guide;

FIG. 11 is a front view of a slat-support guide; and

FIG. 12 is a section view through line 12-12 of FIG. 11.

### DESCRIPTION OF PREFERRED EMBODIMENT

Listed numerically below with reference to the drawings are terms used to describe features of this invention. These terms and numbers assigned to them designate the same features throughout this description.
1. shutter framework
2. face walls
3. edge walls
4. shutter spacer
5. slanted slats
6. right slat-support guide
7. left slat-support guide
8. mullion slat-support guide
9. slat-support cover
10. mullion slat-support cover
11. building structure
12. outward edge of slat
13. side wall of slat-support guide
14. front wall of slat-support guide
15. inward side of slat-support cover
16. inward edge of slat
17. slot
18. slatted-louver aperture

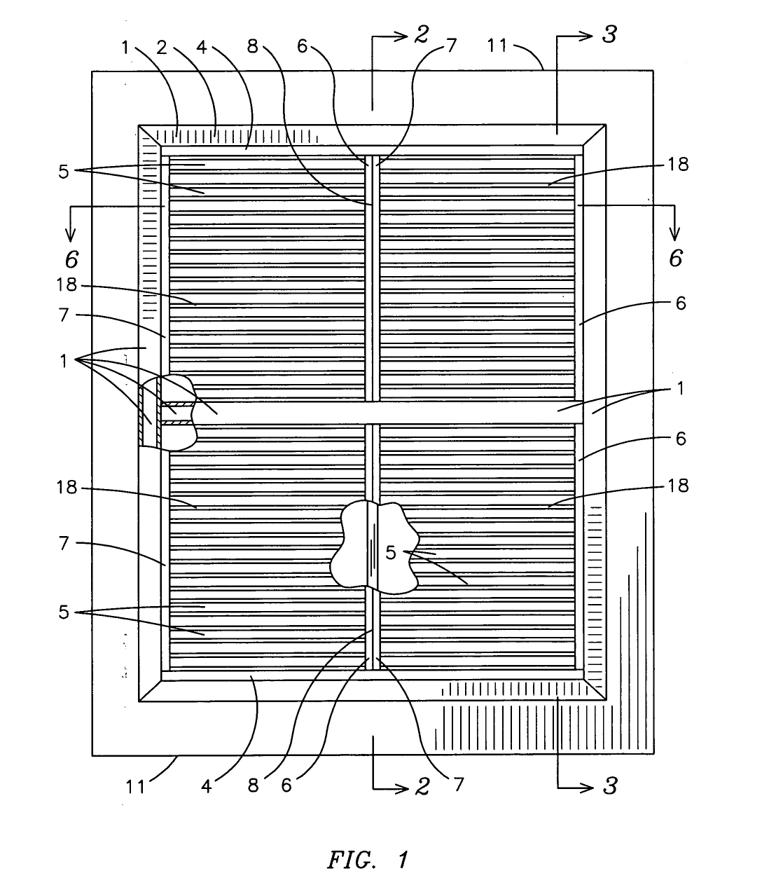

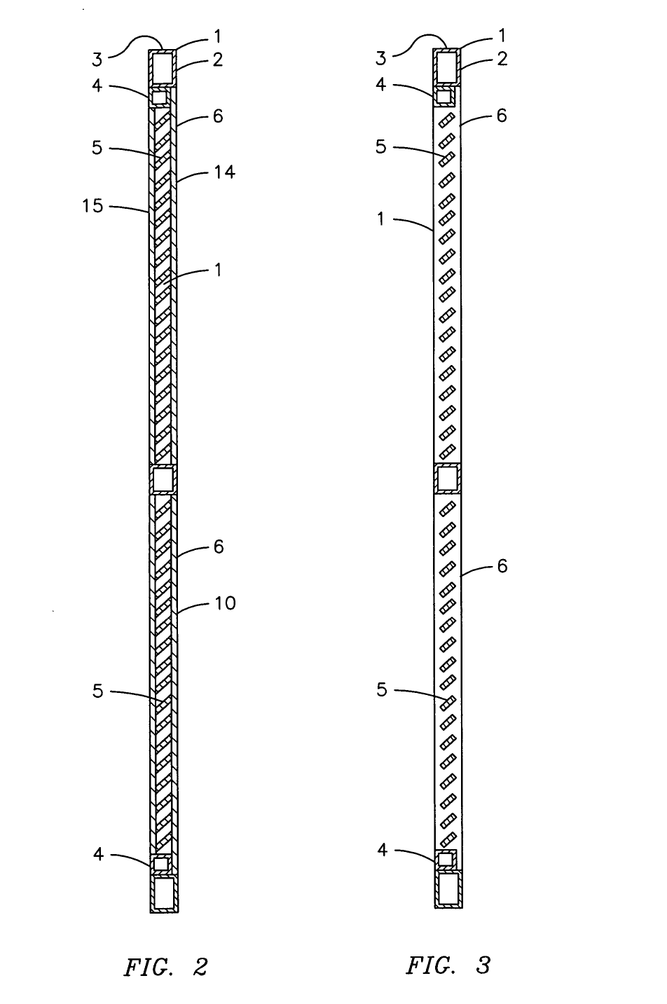

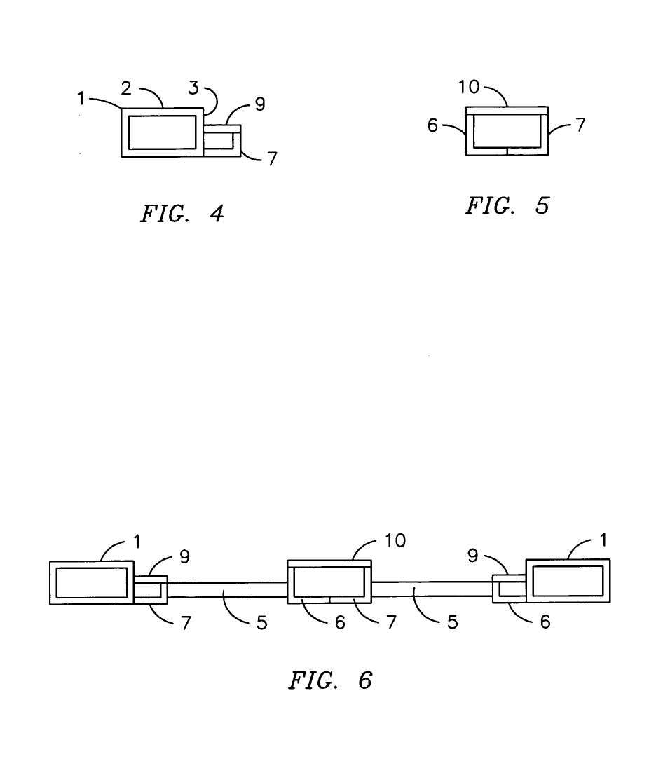

Referring to FIGS. 1-8, a shutter with slat guides has at least one shutter framework 1 that includes structural beams that preferably are structural metal tubes having face walls 2 that may be one to six inches wide and edge walls 3 that are also one to six inches wide or other desired sizes. The frame work may be secured in front of a window or, for decorative purposes, directly to a wall of a building structure 11.

The face walls 2 and the edge walls 3 are preferably about one-eighth inch thick and made preferably of structural aluminum alloy or a substantial equivalent.

The substantial equivalent can be a ferrous alloy that is preferably aluminum and rustproof with either an adequate coating or content of nickel, chrome, aluminum or other stainless constituent.

The shutter framework 1 encompasses slatted-louver apertures 18 having slanted slats 5 with slat ends affixed to the shutter framework 1. The slanted slats 5 have outward edges 12 and inward edges 16 that are oriented horizontally and attached to the right slat-support guide 6, the left slat-support guide 7, and the slat-support cover 9. The slat-support guides 6 and 7 are oriented vertically with ends attached to the shutter spacer 4. Both the outward edges of the slats 12 and the inward edges of the slats 16 are orthogonal to the slat-support guides 6 and 7. The slats 5 feed into the slots 17 located on the side walls of the slat-support guide 13.

The slatted-louver apertures 18 includes an entire slatted enclosure of a plurality of apertures between the slanted slats 5 and the shutter framework 1. The plurality of apertures individually are slanted with preferably about one-half inch of distance of slant orthogonally between surfaces of the slanted slats 5. The slanted slats 5 are preferably flat aluminum bar stock about one-quarter inch thick and one inch wide. Between bottoms and tops of adjacent slanted slats 5, there are horizontal apertures, preferably about one-eighth inch high and having a length that is a length of the slanted slats 5, less a width of the slat-support guides 6 and 7. The slat-support guides 6 and 7 have a side wall 13, a front wall 14, and a back slat-support cover 9. The slat-support guides 6 and 7 are attached to the bottom of the shutter spacer 4 and are preferably welded periodically to the sides of the shutter framework 1. The slat-support guides 6 and 7 and the mullion slat support cover 10 have the appearance of a rectangular mullion so as to give a more aesthetic appearance.

Specifically referring to FIG. 6, a cross-section of slanted slat 5 is shown affixed to slat-support guides 6 and 7. The slat-support guides 6 and 7 and the ends of the slanted slats 5 in turn, are affixed to the shutter framework 1. The slat-support cover 9 may be affixed to the back of the slat-support guides 6 and 7 and to the edge walls 3 of the shutter framework 1.

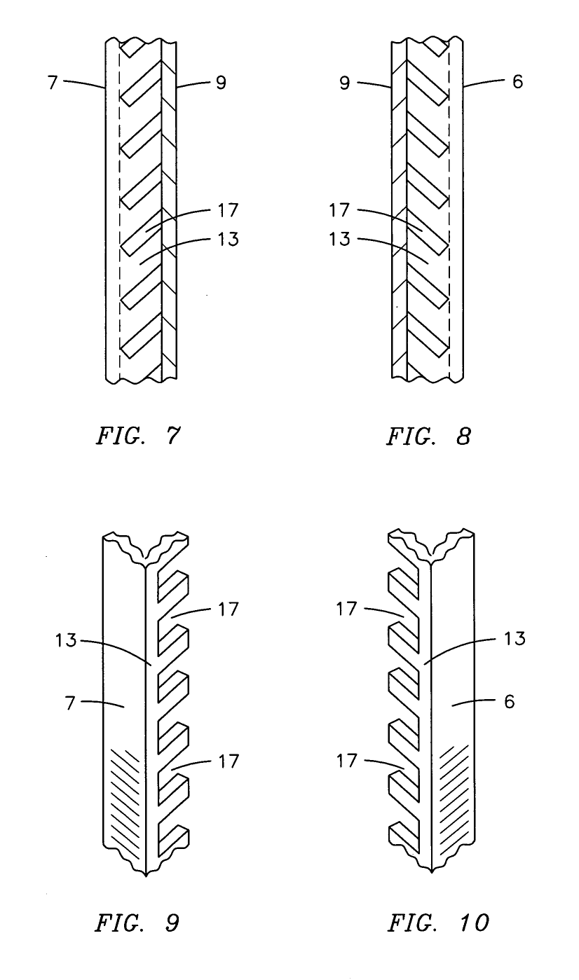

Specifically referring to FIG. 7, a side view of a left slat-support guide 7 is shown without the slanted slats 5. The side wall 13 has slots 17 where the slanted slats 5 feed into. A slat-support cover 9 would be affixed to the outward edge of slats 12 once placed into the slots 17.

Specifically referring to FIG. 8, a side view of a right slat-support guide 6 is shown without the slanted slats 5. The side wall 13 has slots 17 where the slanted slats 5 feed into.

Referring to FIG. 9, a perspective view of a left slat-support guide 7 is shown by itself with slots 17 on, the side wall 13.

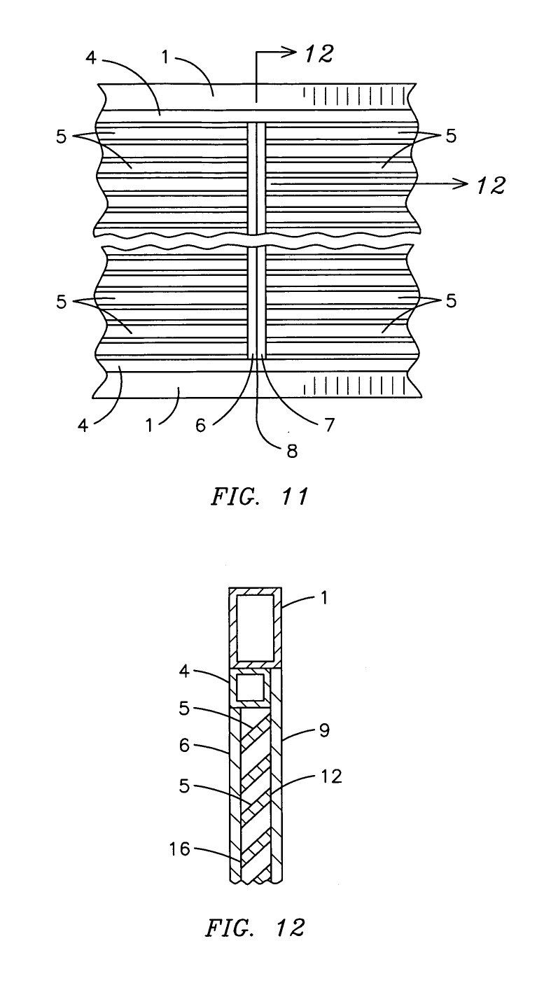

Referring to FIG. 10, a perspective view of a right slat-support guide 6 is shown by itself with slots 17 on the side wall 13.

Referring to FIG. 11, a front view of a mullion slat-support guide 8 is shown.

Referring to FIG. 12, a section of a right slat-support guide 6 is shown. The outward edges 12 of the slanted slats 5 are affixed to the slat-support cover 9.

A new and useful shutter with slat guides having been described, all such foreseeable modifications, adaptations, substitutions of equivalents, mathematical possibilities of combinations of parts, pluralities of parts, applications and forms thereof as described by the following claims and not precluded by prior art are included in this invention.

1. A shutter with slat guides comprising:
at least one shutter framework encompassing slatted-louver apertures;
said shutter framework including structural beams to which ends of slanted slats for the slatted-louver apertures are affixed;
slat-support guides oriented vertically and having ends;
said shutter framework including a shutter spacer to which said ends of said slat-support guides for the slatted-louver apertures are affixed;
said structural beams on said shutter framework affixed to the outside edge of said slat-support guides;
the slanted slats having outward edges that are oriented orthogonally to the mullion slat-support covers;
the slanted slats having inward edges that are oriented orthogonally to the slat-support guides;
the outward edges intermediate the ends of the slanted slats being attached to the mullion slat-support covers; and
the inward edges intermediate the ends of the slanted slats being attached to the shutter framework.

2. The shutter with slat guides of claim 1 wherein.
the structural beams included in the shutter framework are structural metal tubes having a cross section that is rectangular.

3. The shutter with slat guides of claim 1 wherein:
the structural beams included in the shutter framework are structural aluminum tubes having a cross section that is rectangular with face walls and orthogonal edge walls;
the face walls and the edge walls being about one-eighth of an inch thick;
the metal of the structural aluminum tubes being aluminum alloy; and
the structural beams of the shutter framework are affixed together at joining edges.

4. The shutter with slat guides of claim 1 wherein:
the slanted slats include structural flat-bar metal having a cross section that is rectangular.

5. The shutter with slat guides of claim 1 wherein:
the slanted slats are structural aluminum flat bar having a cross section that is rectangular with face walls and edge walls;
the metal of the slanted slats being aluminum alloy;
the ends of the slanted slats are affixed to the shutter framework; and
the inward edges of the slanted slats are affixed to at least one side wall of the slat-support guides.

6. The shutter with slat guides of claim 1 wherein:
the face walls of the slanted slats are spaced apart about one-half inch orthogonally; and
the slanted slats are juxtaposed vertically with dihedral angles of the face walls and dihedral angles of the edge walls being horizontal.

7-11. (canceled)

12. The shutter with slat guides of claim 1 wherein:
said slat-support guides have a front wall, at least one side wall, and a back wall joined together along longitudinal edges of the walls;
the slat-support guides are structural aluminum alloy;
said slat-support guide front and at least one side wall having rectangular cross sections;
said at least one slat-support guide side wall having rectangular cross sections;
said at least one slat-support guide side wall having slots distributed evenly to correspond with shape, size, and direction of slanted slats; and
said slat-support guides have ends which are affixed to the shutter spacer.

13-27. (canceled)

28. The shutter with slat guides of claim 1 further comprising:
at least one slat-support cover affixed to said slat-support guides; and
at least one mullion slat-support cover affixed to at least two adjacent said slat-support guides.
